(19) United States
(12) Patent Application Publication
(10) Pub. No.: US 2014/0097123 A1
(43) Pub. Date: Apr. 10, 2014

(54) INTEGRATED HYDROPROCESSING

(71) Applicant: VENTECH ENGINEERS INTERNATIONAL LLC, Pasadena, TX (US)

(72) Inventors: George ARMISTEAD, Pasadena, TX (US); Simon MAY, Pasadena, TX (US); Bill STANLEY, Pasadena, TX (US)

(73) Assignees: George ARMISTEAD, Pasadena, TX (US); VENTECH ENGINEERS INTERNATIONAL LLC, Pasadena, TX (US); Bill STANELY, Pasadena, TX (US); Simon MAY, Pasadena, TX (US)

(21) Appl. No.: 13/838,266

(22) Filed: Mar. 15, 2013

Related U.S. Application Data
(60) Provisional application No. 61/711,696, filed on Oct. 9, 2012.
(60) Provisional application No. 61/711,714, filed on Oct. 9, 2012.
(60) Provisional application No. 61/766,924, filed on Feb. 20, 2013.

(51) Int. Cl. C10G 7/08; C10G 47/00; C10G 49/00; B01J 19/00

(52) U.S. Cl. CPC C10G 7/08; B01J 19/00; C10G 47/00; C10G 49/00
USPC 208/85; 422/608; 208/264

(57) ABSTRACT

The present invention relates to a method and system for converting gas to liquids and fractionating crude oil or condensate. Advantageously, it includes hydroprocessing at least a portion of the fractionated product and at least a portion of the Fischer-Tropsch products in the same hydroprocessor. Among other advantages the present invention provides for improved output quality for diesel and/or naphtha, reduced transportation and/or storage costs, and/or enhanced energy efficiency.

### CROSS-REFERENCE TO RELATED APPLICATION(S)

This application claims benefit of priority from U.S. patent application Ser. No. 61/711,696 filed Oct. 9, 2012; from U.S. Patent Application No. 61/711,714 filed Oct. 9, 2012; and from U.S. Patent Application No. 61/766,924 filed Feb. 20, 2013; all of which applications are incorporated by reference herein in their entirety.

### FIELD OF THE INVENTION

The present invention pertains to, for example, improved methods for fractionating crude or condensate and converting gas to liquids in an integrated process facility.

### BACKGROUND AND SUMMARY OF THE INVENTION

There has been an increased interest in converting natural gas to liquid hydrocarbons with the increasing availability of economical natural gas resulting from the development of new drilling techniques for the production of non-conventional shale gas reserves. The conventional alternative means of converting natural gas to liquid fuels is based upon two basic technologies: (1) conversion of natural gas to hydrocarbon products such as diesel, naphtha, LPG's, lube oils, and/or specialty waxes utilizing Fischer Tropsch technology; and, (2) conversion of natural gas to methanol, dimethyl ether (DME), gasoline and/or LPGs utilizing natural gas to methanol to gasoline technology. The instant invention pertains in certain embodiments to the first methodology, i.e., conversion of natural gas to hydrocarbon products utilizing Fischer Tropsch reactor technology (referred to herein as “FT GTL”).

In FT GTL natural gas is first reformed to produce syn-gas primarily consisting of hydrogen and carbon monoxide; the syn-gas is next used in a Fischer Tropsch reactor where FT products are produced. The FT products often comprise paraffinic waxes, distillate liquid fuel products, and mixtures thereof. The FT products are then hydro-processed into desired hydrocarbon end products which may include, for example, diesel, kerosene, jet fuel, naphtha, lube oils, specialty wax products, LPGs and mixtures thereof. The characteristics of diesel made in an FT GTL process are often very good, e.g., a cetane typically greater than 70 and with little to no sulfur. Unfortunately, commercial applications of conventional FT GTL technologies are currently limited to very large projects (up to 130,000 barrels per day of capacity) that have not been feasible at lower capacities for field or remote locations due to very high capital cost requirements and the large concentration of natural gas necessary to justify such a project. However, with improvements in the FT technology some smaller FT GTL projects may now be technically possible even though not economic given the projected operating and capital cost per barrel produced. Accordingly, what is needed are improved methods of efficiently and economically integrating FT GTL projects with other projects to allow lower operating and capital costs.

As a result of improved oil production technologies, there has been a substantial increase in the production of non-conventional shale oil production. There has also been development of additional conventional oil resources in remote locations. Unfortunately, in each case the oil production may be far away from any existing refining infrastructure necessary to process the oil. Further, much of this new oil production has associated natural gas which must either be recovered or flared as the oil is produced. This may result in undesirable high levels of associated natural gas flaring until pipeline capacity can be added to move the natural gas to market. As a result of the need to refine oil being produced distant from existing refinery capacity, small (less than 40,000 barrel per day) refineries are being developed in some of these locations to be nearer this new oil production. These smaller refining projects often have limited or no hydroprocessing capabilities due to the capital cost of the hydrocrackers or hydro-treaters and also due to the need for hydrogen production required for hydroprocessing. The lack of hydroprocessing capability is often a limiting factor for small refineries and may preclude or limit their ability to produce, for example, ultra low sulfur diesel.

It would be of significant economic benefit to both the development of new refining projects, and for the development of new FT GTL capacity if improved methods and systems could be developed that solve the aforementioned limitations. It would be of further benefit if such improved methods and systems were able to integrate crude distillation with FT GTL projects on a smaller scale and/or combine such with hydroprocessing. The instant invention meets at least these needs and more.

In one embodiment, the instant invention pertains to a process comprising fractionating crude oil, condensate, or a mixture thereof in a fractionator to produce a fractionated product comprising diesel, kerosene, or a mixture thereof. Synthesis gas is employed in a Fischer-Tropsch reactor to produce one or more Fischer-Tropsch products. The process then involves hydroprocessing at least a portion of the fractionated product and at least a portion of the Fischer-Tropsch products in the same hydroprocessor.

In another aspect the invention pertains to an integrated system for converting gas to liquids and fractionating crude oil or condensate. The system comprises a fractionator for producing a fractionated product comprising diesel, kerosene, or a mixture thereof from crude oil, condensate, or a mixture thereof The system also comprises a Fischer-Tropsch reactor for producing one or more Fischer-Tropsch products from a synthesis gas. Advantageously, a hydroprocessor is operably connected to the fractionator and Fischer-Tropsch reactor such that the hydroprocessor is capable of hydroprocessing at least a portion of the fractionated product and at least a portion of the Fischer-Tropsch products.

### BRIEF DESCRIPTION OF THE DRAWINGS

FIG. 1 shows a specific embodiment of an integrated hydroprocessing system.

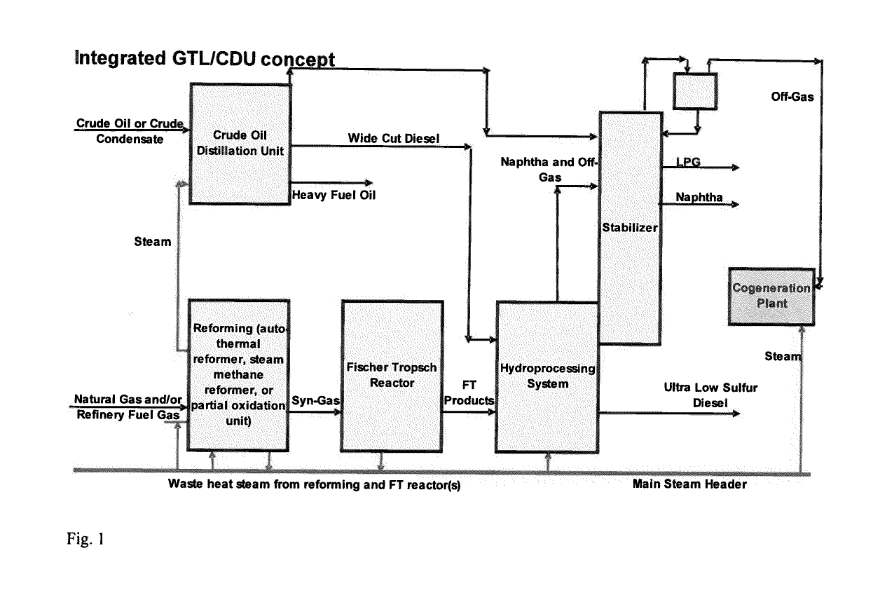

FIG. 2 shows another integrated GTL/cracked products concept of the present invention.

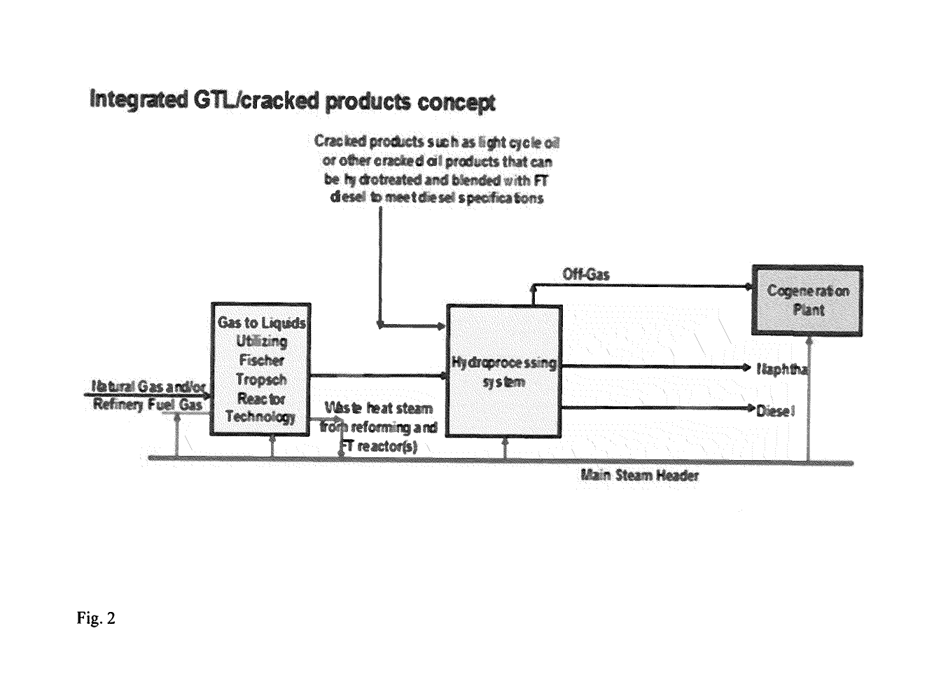

### DETAILED DESCRIPTION OF THE INVENTION

The instant system may include: a crude oil fractionator; a stabilizer to stabilize naphtha or other fractions from the crude oil fractionator, hydroprocessor, and/or from the FT GTL; a gas reformer to produce syn-gas (and potentially hydrogen that can be employed in, for example, hydroprocessing); a Fischer-Tropsch reactor to produce FT products from syn-gas produced in the gas reformer; and a hydroprocessor to hydroprocess both the FT products from the FT GTL, and wide-cut diesel from the crude distillation unit. Wide-cut diesel generally means the fraction with the ASTM D-86 cut point between about 250 and 1000 degrees Fahrenheit. The wide-diesel cut typically comprises, diesel, kerosene, the heavy portion of the naphtha, and the light portion of the heavy fuel oil cut.

At least a portion up to all of any hydrogen used for hydroprocessing may advantageously be provided by the FT GTL reformer. Preferably all the units in the system are located in the same vicinity so that excess heat and/or other energy generated from the exothermic processes in the FT GTL portion of the integrated plant may be efficiently transferred and used effectively throughout the system. However, in some embodiments units such as the fractionator may be off-site and the un-cracked wide diesel cut may then be shipped, transferred, or moved via pipeline to the FT GTL plant, and the hydroprocessor unit then used to hydro-process the un-cracked wide diesel cut.

### Fractionating

The fractionator may be any unit that is conventionally employed for fractionating crude oil, condensate, or a mixture thereof. Such fractionators are known in the art and sometimes referred to as crude oil distillation units. The units typically distill crude oil, condensate, or mixture thereof into fractions comprising different boiling ranges as desired. Usually the incoming stream is heated via any desired mechanism and desalted to remove such salts as sodium chloride. The temperature can be raised by any convenient means but most usually is some sort of fired heater or the like. Generally, the fractionation conditions may be any such that the desired fraction is obtained. For example, in the case of the desired fraction being wide-cut diesel a temperature and pressure are employed to obtain a fraction with the ASTM D-86 cut point between about 250 and 1000 degrees Fahrenheit. Thus, the skilled artisan realizes that in this situation temperatures of between about 250 and 1000 degrees Fahrenheit and a pressure of 1 atmosphere, for example, may be employed.

The output of the fractionator varies depending upon the composition of the input and conditions employed. Typically, a composition comprising various amount of, for example, naphtha, off-gases, wide cut diesel, and heavy fuel oil may result. Each of these fractions may be condensed and/or cooled via heat exchanger or other means as desired and processed further. Any removed heat may be recycled.

In one embodiment of the instant invention a fractionated portion comprising, for example, naphtha and any off-gases may be further processed via a stabilizer. This may produce LPG, naphtha, and off-gases. These off-gases may be useful, for example, in a cogeneration unit, in another plant, or even as fuel in a system of the instant invention. The LPG and/or naphtha can be further processed as desired. Useful processing conditions are known in the art. Similarly, any heavy fuel oil generated via the fractionation may be further processed or employed in any conventional manner.

The wide cut diesel is usually transferred or otherwise sent to a hydroprocessor for hydroprocessing. However, advantageously as described in detail below the hydroprocessor is also capable of hydroprocessing not only at least this or another portion of the fractionated product, but also, capable of hydroprocessing at least a portion of one or more Fischer-Tropsch products. These Fischer-Tropsch products are generated from, for example, reforming of natural gas or refinery fuel gas to form a product comprising synthesis gas which is then converted to Fischer-Tropsch products in a Fischer-Tropsch reactor.

### Reforming

The reforming of natural gas, refinery fuel gas, or a mixture thereof may be conducted in any convenient manner. The process conditions and/or equipment employed in the reforming may vary depending upon the specific composition of the natural gas, refinery fuel gas, or mixture, as well as, the precise composition of the synthesis gas desired, e.g., ratio of hydrogen, carbon monoxide, and/or carbon dioxide. The reforming equipment differs depending on the input composition, process conditions, and desired output. In various embodiments such equipment may include an autothermal reformer, steam methane reformer, partial oxidation unit or even in some embodiments a combination thereof. The reforming equipment and conditions employed are not particularly critical so long as the desired composition of synthesis gas is suitable for processing in the Fischer-Tropsch reactor. Advantageously, at least a portion of the hydrogen generated during reforming may be employed during hydroprocessing.

### Employing Synthesis Gas in F-T Reaction

At least a portion of the synthesis gas generated in the reformer may be employed in a Fischer-Tropsch reaction. Fischer-Tropsch reactors and conditions are known in the art and the specifics are not particularly crucial to the practice of the present invention. That is, any equipment and/or appropriate conditions may be employed so long as at least a portion of or preferably up to all of the resulting Fischer-Tropsch products are capable of being hydroprocessed along with at least a portion or preferably up to all of the wide cut diesel described above. Typically, the Fischer-Tropsch products comprise paraffinic waxes, distillate liquid fuel products, and mixtures thereof.

### Hydroprocessing

The instant invention is unique in regard to at least the hydroprocessing step. That is, hydroprocessing usually includes hydroprocessing at least a portion of the fractionated product and at least a portion of the Fischer-Tropsch products in the same hydroprocessor. These two different portions may enter the hydroprocessor in any convenient manner so long as each different portion is hydroprocessed simultaneously for at least some period of time. That is, the two or more different portions (fractionated product and Fischer-Tropsch product) may be blended in advance and introduced in one stream to the hydroprocessor. Alternatively or additionally, there may be one or more streams of fractionated product and one or more streams of Fischer-Tropsch product entering the hydroprocessor and blending, if any, occurs within the hydroprocessor. The relative proportions of fractionated product to Fischer-Tropsch product entering the hydroprocessor vary depending upon many factors. Generally, the ratio of fractionated product to Fischer-Tropsch product is from about 0.5:1 to about 5:1, or about 0.75:1 to about 4:1, or about 1:1 to about 3.5:1 based on weight.

Advantageously, such hydroprocessing of the aforementioned may include, for example, hydrogenating, hydrocracking, hydroisomerization, or hydrotreating. That is, the hydroprocessing equipment and conditions may differ depending upon the desired products. Often desired products include, but are not limited to, those compositions comprising various amounts of naphtha, diesel and particularly ultra low sulfur diesel, as well as, mixtures thereof.

Advantageously, the hydroprocessing conditions employed herein may be similar to conventional hydroprocessing conditions for hydroprocessing either fractionated product or p Fischer-Tropsch products. The specific hydroprocessing conditions such as temperature and pressure vary depending upon the inputs and desired products, however, in general the temperature employed during hydroprocessing may be at least about 450, or at least about 500, or at least about 550 degrees Fahrenheit. On the other hand, the temperature may usually be less than about 950, or less than about 900, or even less than about 850 degrees Fahrenheit for a majority of hydroprocessing time. The pressure employed may vary depending upon the temperature selected and vice-versa. That is, in general if one employs a lower temperature, then the selected pressure should be higher. Generally, at the temperatures described above the pressure employed may typically include a pressure of at least about 500, or at least about 550, or at least about 550 psig up to about 2000 or up to about 1500 psig for a majority of hydroprocessing time.

Advantageously, even though conventional or similar hydroprocessing conditions may be employed the products of the hydroprocessing often have surprising and unexpected advantages and properties. While not wishing to be limited to any particular theory it is believed that these properties result due to the unique starting material being hydroprocessed, i.e., mixture of fractionated product such as wide diesel cut and Fischer-Tropsch product. That is the properties of the product from hydroprocessing the mixture are generally better than a product that would result from hydroprocessing either portion alone. Advantageously, desired properties of the product may be adjusting by varying, for example, the hydroprocessing conditions. In this manner, a diesel product may be made that complies with an individual country's regulatory requirements for cetane, sulfur, and the like. For example, the hydroprocessing conditions may be readily adjusted to obtain a product having one or more of the following: (a) cetane of at least about 40, or at least about 45, or even at least about 50 or more, ; and/or (b) a sulfur content of or below about 50 ppm, or even below about 10 or 5 ppm.

### Recycle of Heat

The combination of steps described above may advantageously recycle any heat or waste heat to other steps. For example, any heat generated in the Fischer-Tropsch reaction may be transferred to the reforming step and/or pre-heat of gases employed in the reforming step. IN addition or alternatively, any heat generated in the reforming and/or Fischer-Tropsch reaction may be transferred in the form of steam or other energy to the fractionation unit, cogeneration plant or some other desirable location in any convenient manner.

### Modular Units

In one advantageous embodiment one or more of the described units are modular. That is, one or more of any units employed in the system, e.g., fractionator, reformer, Fischer-Tropsch reactor, stabilizer and/or hydroprocessor, are modular units. Each of the Fischer-Tropsch reactor units may have a capacity of less than about 5000, or less than about 3000, or even less than about 1500 barrels per day of F-T products. Similarly, the fractionator units may have a capacity in terms of crude oil used as feedstock of, for example, less than about 40,000, or less than about, 10,000 or even less than about 2,500 barrels per day.

By modular is meant of sufficiently limited size and weight to potentially be shipped as a unit by rail or truck. For shipping by truck this may mean, for example, dimensions of 14 feet or less by 14 feet or less by 55 feet or less with a weight of 80 or below or even 60 tons or below. Modular units are advantageous in that at least 25%, at least 50%, or even at least about 7% of the unit based on total installed cost may be constructed within a factory which is remote from the install site. It can then be shipped to the install site in a substantially pre-assembled manner. In this manner, workers and equipment may remain protected from the elements during a significant portion of the construction process. That is, the instant invention may advantageously be capable of being implemented at the site of, for example, natural gas production and/or crude oil production

### Blending

In another advantageous embodiment it is contemplated that blending may be advantageous. That is, upon producing one or more Fischer-Tropsch products from a synthesis gas that have, for example, a cetane rating and/or sulfur content as described above it may be advantageous to combine such products in a convenient manner with a cracked hydrocarbon such as light cycle oil to produce a blended hydrocarbon. The cracked hydrocarbon may be any convenient product such as obtained via fluid cracking, thermal cracking, catalytic cracking or some product obtained via a combination. In this manner, combined light cycle oil subjected to appropriate hydroprocessing conditions may be sufficient to produce a hydrotreated light cycle oil with a low sulfur content.

Some embodiments pertaining to blending include, for example:

A process to produce a blended hydrocarbon comprising: producing one or more Fischer-Tropsch products from a synthesis gas wherein said products may have a cetane rating of greater than about about 40, or at least about 45, or even at least about 50 or more,; and/or (b) or below about 50 ppm, or even below about 10 or 5 ppm; cracking a hydrocarbon to produce a light cycle oil or other cracked oil; blending one or more Fischer-Tropsch products with the light cycle oil or other cracked oil to produce a blended hydrocarbon.

The process may include any cracking, for example, fluid cracking, thermal cracking, catalytic cracking. Similarly, the process may further comprise hydroprocessing the light cycle oil or other cracked oils prior to blending wherein said hydroprocessing conditions are sufficient to produce a hydrotreated light cycle oil with a low sulfur content.

The system also may comprise a cogeneration unit to employ fuel gas generated in in any portion of the process such as fractionation, hydroprocessing, and the like.

Unless specifically defined or used otherwise, all technical or scientific terms used herein have the same meaning as commonly understood by one of ordinary skill in the art to which this invention belongs. Although any methods and materials similar or equivalent to those described herein can be used in the practice or testing of the present invention, the preferred methods and materials are better illustrated by the use of the following non-limiting examples, which are offered by way of illustration and not by way of limitation.

### EXAMPLES

The following examples are presented to further illustrate and explain the claimed subject matter and should not be taken as limiting in any regard. All weight percentages are based on the total composition unless stated otherwise and all mixing is conducted at prevailing suitable temperatures unless stated otherwise.

The claimed subject matter is not to be limited in scope by the specific embodiments described herein. Indeed, various modifications of the invention in addition to those described herein will become apparent to those skilled in the art from the foregoing description. Such modifications are intended to fall within the scope of the appended claims.

All references cited herein are incorporated herein by reference in their entirety to the extent that they are not inconsistent and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

### Representative Embodiments

Among the embodiments envisioned as being within the scope of the invention are the following:

The inventive process integrates two processes, i.e. fractionation of crude oil or condensate and Fischer Tropsch Gas to Liquids processes.

Fractionation of Crude Oil or Condensate is typically a process whereby conventional crude oil distilling column and stabilizer (“Crude Unit”) is used to fractionate crude oil or condensate into products including butane and lighter gases; naphtha; kerosene; light gas oil; heavy gas oil; and, fuel oils.

Fischer Tropsch Gas to Liquids (“FT GTL”) is typically a process utilizing either an auto-thermal reformer; a steam methane reformer; or a Partial Oxidation reforming process to produce syn-gas from natural gas (and related gaseous hydrocarbons typical in natural gas streams) primarily consisting of hydrogen (H2) and carbon monoxide (CO), then used in a Fischer Tropsch (“FT”) reactor system, producing wax and other FT products to be further hydroprocessed and fractionated into finished products including lube oils, and/or diesel and naphtha.

In the Integrated Fractionator/GTL Process (IFGP) process of the present invention, and dependent upon the characteristics of the crude oil or condensate, the diesel and kerosene cuts (or combined referred to as wide cut diesel) are delivered to a common hydroprocessor also being used to hydroprocess the products of the FT GTL. Further, steam produced from waste heat in the FT GTL process is utilized in the integrated plant.

The IFGP process can either be stick-built, or suited for modularized construction for improved product applications in areas rich in crude oil, condensate, and natural gas (including associated natural gas).

There are a number of expected benefits of which the following are a non-exhaustive list:

Significantly lower capital cost and operating costs, and improved output quality for diesel & naphtha vs. a stand-alone Crude Unit and a stand-alone FT GTL;

opportunity for modularization of the technology significantly reduces transportation and storage costs of alternatively shipping the crude products to large refineries for processing;

provides marketable products at the processing location; and/or

enhanced energy efficiency.

Provides opportunity for modularization technology to shorten implementation schedule and facilitates use of technology in remote areas.

Modular construction gives opportunity to relocate facility as oil or gas is expended at given area.

Eliminates flaring.

1. A process comprising:
fractionating crude oil, condensate, or a mixture thereof in a fractionator to produce a fractionated product comprising diesel, kerosene, or a mixture thereof;
employing synthesis gas in a Fischer-Tropsch reactor to produce one or more Fischer-Tropsch products; and
hydroprocessing at least a portion of the fractionated product and at least a portion of the Fischer-Tropsch products in the same hydroprocessor.

2. The process of claim 1 which further comprises generating heat in the Fischer-Tropsch reaction and transferring at least a portion of said heat to the fractionator.

3. The process of claim 1 which further comprises converting natural gas to synthesis gas wherein at least a portion of said synthesis gas is employed in the Fischer-Tropsch reaction.

4. The process of claim 1 wherein said hydroprocessing comprises hydrogenating, hydrocracking, hydroisomerization, or hydrotreating.

5. The process of claim 1 wherein the synthesis gas is produced from an autothermal reformer, a steam methane reformer, or a partial oxidation reformer.

6. The process of claim 1 wherein the hydroprocessing produces naphtha, diesel, gas oils, LPG, kerosene, jet fuel, or a mixture thereof.

7. (canceled)

8. (canceled)

9. (canceled)

10. (canceled)

11. (canceled)

12. The process of claim 1 wherein said hydroprocessing comprises hydrogenating.

13. The process of claim 1 wherein said hydroprocessing comprises hydrocracking.

14. The process of claim 1 wherein said hydroprocessing comprises hydroisomerization.

15. The process of claim 1 wherein said hydroprocessing comprises hydrotreating.

16. The process of claim 1 wherein the synthesis gas is produced from an autothermal reformer.

17. The process of claim 1 wherein the synthesis gas is produced from a steam methane reformer.

18. The process of claim 1 wherein the synthesis gas is produced from a partial oxidation reformer.

19. The process of claim 1 wherein the hydroprocessing produces naphtha, diesel, gas oils, LPG, kerosene, jet fuel, or a mixture thereof.

20. The process of claim 1 wherein the hydroprocessing produces naphtha.

21. The process of claim 1 wherein the hydroprocessing produces diesel.

22. The process of claim 1 wherein the hydroprocessing produces gas oils.

23. The process of claim 1 wherein the hydroprocessing produces LPG.

24. The process of claim 1 wherein the hydroprocessing produces kerosene.

25. The process of claim 1 wherein the hydroprocessing produces jet fuel.

26. The process of claim 1 wherein the fractionated product comprises wide cut diesel.

27. The process of claim 1 wherein the ratio of fractionated product to Fischer-Tropsch product is from about 0.5:1 to about 5:1 based on weight.

28. The process of claim 1 wherein the ratio of fractionated product to Fischer-Tropsch product is from about 0.75:1 to about 4:1 based on weight.

29. The process of claim 1 wherein the ratio of fractionated product to Fischer-Tropsch product is from about 1:1 to about 3.5:1 based on weight.

30. The process of claim 1 wherein the fractionated product is processed via a stabilizer before hydroprocessing.
